(19) United States
(12) Patent Application Publication
(10) Pub. No.: US 2008/0204733 A1
(43) Pub. Date: Aug. 28, 2008

(54) Sensing in Meat Products and the Like

(76) Inventors: Gareth Jones, Mid Glamorgan (GB); Shiang Pheng Ong, Swansea (GB); Gareth Jones, Ynys Mon (GB)

Correspondence Address: JORDAN AND HAMBURG LLP, 122 EAST 42ND STREET, SUITE 4000, NEW YORK, NY, 10168, US

(21) Appl. No.: 11/795,159

(22) PCT Filed: Jan. 12, 2006
(86) PCT No.: PCT/GB06/00109

§ 371 Date: Nov. 28, 2007

(30) Foreign Application Priority Data
Jan. 12, 2005 (GB) 0500570.7

(51) Int. Cl. G01N 21/00

(52) U.S. Cl. 356/237.1

(57) ABSTRACT

Methods and devices for sensing foreign bodies and the like in products, such as food products, are described. Said products, which are generally light transmissive, are backlit by a source of light and an image of said object is taken. In one form of the invention, the light is polarized both before an after transmission through the said object. In another form of the invention, the products are conveyed by a holder having gaps therein that allows the light from said light source to pass through said holder. In some forms of the invention, the source of light has a power output dependent on the dimensions of said object.

This invention relates to a method and a device for sensing foreign bodies and the like in products, such as food products.

The preparation of prepared meat products, such as chicken breast fillets can be highly automated. One area where extensive use of human operators is typically used is in the checking of the meat products. Major issues here include screening for discoloured meat and the detection of the presence of bone in the meat product. Another area typically requiring human screening is the detection of bone in the fish filleting process.

The presence of bone and bone fragments in some prepared meat products must be kept to an absolute minimum.

Discoloration of meat products can be caused in a number of ways, for example by blood spotting or bruising. Even in circumstances where this does not affect the quality of the meat product, discoloration may result in a product that is unattractive to the consumer, thereby reducing the value of that product.

As noted above, checking for defects such as bone fragments and discoloration is typically a labour-intensive process. This is not only expensive, but can also be an error-prone process. It would be advantageous if the checking processes could be automated at least to some degree.

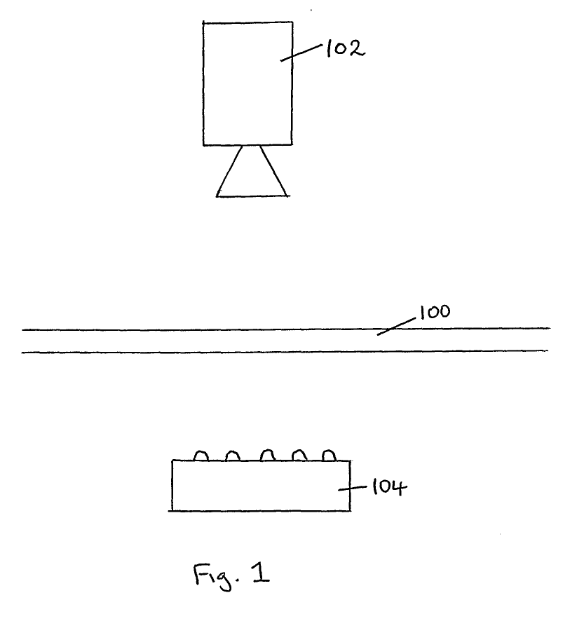

FIG. 1 shows a prior art system for detecting the presence of bone or bone fragments in meat. The system of FIG. 1 includes a conveyor 100 on which a number of meat products are transferred, an imaging device 102 for taking images of the meat products and a light source 104 for providing backlighting of the meat products on the conveyor 100.

US 2003/0098409 describes a system for detecting foreign bodies in process streams of foodstuffs, for example the detection of bones or bone fragments in chicken meat. The system of US 2003/0098409 utilises optical backlighting. A substantially monochromatic light source having a wavelength of between about 500 nm and 600 nm is directed at the food stream. An image of the food stream is taken and the presence of foreign material is determined when a portion of the detected image exceeds a predetermined threshold. The selection of 500 nm to 600 nm as a suitable wavelength of light is derived from results of tests of the transmission of light of different frequencies through muscle, fat and bone. The greatest contrast between bone and other material was found to be in the 500 nm to 600 nm range.

There are a number of problems associated with the prior art methods and devices.

Meat products scatter light. Accordingly, it becomes more difficult to apply the teaching of the prior art as the meat products become larger since the amount of light required to obtain an adequate image becomes large. In order to reach the imaging device, light from the light source must penetrate the conveyor and the meat product.

The problem of obtaining an adequate image, particularly with larger meat products, can be addressed to some extent by increasing the power output of the light source. This has many problems, including the potential for heating the meat products.

In some arrangements a significant amount of light can reach the imaging device without having passed through any meat product, making it more difficult to generate a useful image of the meat product since light that does not pass through the meat product is not attenuated to the degree that light that does pass through the meat product is. The increased glare in the image caused by the unfiltered light can reduce the ability of the system to detect bones of small dimensions.

A further problem in some arrangements is that the product under test must be held in place in some way, without the optical properties of the means that holds it in place having an impact on the image generated.

The use of backlighting does not assist in the detection of discolouration and other marking of the surface of meat products.

The device and method of the present invention seeks to address at least some of the problems associated with the prior art systems and/or to provide alternatives to the devices and methods of the prior art.

The present invention provides an apparatus suitable for use in the detection of one or more regions within a generally light-transmissive object, the apparatus comprising a source of light, an imaging device and first and second polarizing filters, wherein: said one or more regions are substantially non-light-transmissive at the frequency(s) of light output by said source of light; light transmissive portions of said generally light-transmissive object perturb the polarization of said light; in use, said source of light is used to backlight said object and said imaging device is used to take an image of said object when said object is backlit by said source of light; and said first polarizing filter is positioned to polarize said light before transmission of said light through said object and said second polarizing filter, arranged to have a polarization angle substantially perpendicular to that of said first polarizing filter, is positioned to polarize the light after transmission through said object. By way of example, the generally light-transmissive object may be a meat product, such as a chicken breast fillet, and the generally non-light-transmissive object may be a bone fragment.

The second polarizing filter is therefore provided to exclude light which has not undergone polarisation scattering within the object under test, such excluded light being that that has not passed through the object under test.

The present invention further provides an apparatus suitable for use in the detection of one or more regions within a generally light-transmissive object, the apparatus comprising a source of light, an imaging device and a holder for holding said object in a position between said source of light and said imaging device, wherein: said one or more regions are substantially non-light-transmissive at the frequency(s) of light output by said source of light; in use, said source of light is used to backlight said object and said imaging device is used to take an image of said object when said object is backlit by said source of light; and said holder is provided with gaps to allow light from said light source to pass through said holder. By way of example, the generally light-transmissive object may be a meat product, such as a chicken breast fillet, and the generally non-light-transmissive object may be a bone fragment.

The present invention yet further provides an apparatus comprising a source of light and an imaging device, wherein the apparatus is suitable for use in the detection of one or more regions within a generally light-transmissive object, wherein said one or more regions are substantially non-light-transmissive at the frequency(s) of light output by said source of light, wherein, in use, said source of light is used to backlight said object and said imaging device is used to take an image of said object when said object is backlit by said source of light, wherein said source of light has a power output dependent on the dimensions of said object. By way of example, the generally light-transmissive object may be a meat product, such as a chicken breast fillet, and the generally non-light-transmissive object may be a bone fragment. In some forms of the invention, the power output of said source of light is spatially variable in dependence on the dimensions of the object under test.

In some forms of the invention, the apparatus comprises a first and a second polarizing filter, wherein, in use, said first polarizing filter is positioned to polarize said light before transmission of said light through said object and said second polarizing filter, arranged to have a polarization angle substantially perpendicular to that of said first polarizing filter, is positioned to polarize the light after transmission through said object. In some forms of the invention, the generally light-transmissive object changes the polarisation of the light that passes through it. Accordingly, light that has not passed through that object is substantially attenuated by the combination of the first and second polarising filters, but light that has passed through the said object is not generally so attenuated.

In some forms of the invention including first and second cross-polarized filters, the light transmissive portion of said generally light transmissive object perturb the polarization of said light in a generally random manner. In other forms of the invention including first and second cross-polarized filters, the light transmissive portion of said generally light transmissive object perturb the polarization of said light in a non-random manner.

In some forms of the invention, a holder is provided for holding said object in a position between said source of light and said imaging device. The holder may be provided with gaps to allow light from said light source to pass through said holder. Providing gaps in the holder enables light to pass through the holder.

The gaps in the holder could take a number of different forms. The gaps could be in the form of holes in the conveyor structure. Alternatively, the conveyor could consist of rollers, with the rollers being spaced apart, thereby defining the said gaps. In a preferred form of the invention, the gaps are smaller than either the light source being used or the object intended to be measured by the apparatus.

In forms of the invention having a holder, said holder may be made of a substantially opaque material. The said holder may be a conveyor arranged to transfer said object to said position between said source of light and said imaging device. Providing an opaque conveyor with gaps to allow light to pass therethrough ensures that light that passes through the generally light-transmissive object is not affected by the optical properties of the conveyor. This is particularly advantageous when a conveyor with gaps is used in conjunction with the cross-polarization arrangement described above, since the functioning of the cross-polarized filters is unaffected by light passing through the gaps in the conveyor.

In forms of the invention include both a holder as described above and first and second cross-polarized filters, the second polarizing filter is provided to exclude light which has not undergone random polarisation scattering within the object under test, such excluded light being that that has passed through the gaps in the holder, but has not passed through the object under test.

In some forms of the invention, the source of light has a power output dependent on the dimensions of said object. This improves the uniformity of the light after it has passed through the generally light-transmissive object. In some forms of the invention, the power output of said source of light is spatially variable in dependence on the dimensions of the object under test.

The source of light may comprise a plurality of sources of light. For example, the source of light may be an LED array.

Means for determining the planar dimensions of the object may be provided, wherein each of said plurality of light sources outputs light only when a part of said object is located between that light source and said imaging device. Said means for determining the planar dimensions of the object may comprise a second source of light, wherein said second source of light is used to light said object and said imaging device is used to take an image of the light from said second light source that is reflected from said object, thereby obtaining an image of said second object. This arrangement has two advantages: reducing glare caused by light that does not pass through the generally light-transmissive object and reducing the generation of unwanted light which has a number of benefits, including reducing unnecessary heat generation.

Alternatively, or in addition, means for determining the cross-sectional dimensions of the object may be provided, wherein each of said plurality of light sources is arranged so that the power output of that light source is dependent on the cross-sectional dimensions of the object. Furthermore, the power output of each light source in the plurality may be dependent on the cross-sectional dimension of the object at the point between that light object and the imaging device. In this way, the illumination can be provided such that, as far as possible, changes in the levels of light that has passed through the generally light-transmissive object are caused by changes in the density of that object, rather than changes in the thickness of that object.

In one form of the invention, said means for determining the cross-sectional dimensions of the object comprises an emitter-receiver pair located either side of said object.

The light output by said light source may have a wavelength in the range 600 nm to 1000 nm. Said light more preferably has a wavelength in the range 600 to 700 nm and still more preferably in the range 630 to 660 nm. The wavelength may be advantageously chosen so that it is relatively highly transmissive through the generally light-transmissive object. By way of example, it is noted that in tests, light having a wavelength of 640 nm had a particularly high level of transmission through chicken breast meat.

The said source of light is preferably an LED array, although other light sources, such as lamps, are possible.

A diffuser may be positioned between said LED array and said object. The use of a diffuser assists in removing images of the LEDs themselves. In an alternative arrangement, a collimating lens is provided instead of a diffuser.

The said one or more regions may include a foreign body. The said one or more regions may include bone.

In some forms of the invention, a third source of light is provided, wherein said apparatus is suitable for use in the detection of one or more second regions, wherein said one or more second regions have a different reflectivity to the remainder of the object at the frequency(s) of light output by said third source of light, wherein, in use, said third source of light is used to light said object and said imaging device is used to take an image of the light as it is reflected from said object. Said second regions may be bruised or discoloured regions of said generally light-transmissive object. Said third source of light may be the second source of light referred to above in relation to the means for determining the planar dimensions of the said object.

Third and fourth polarizing filters may be provided, wherein, in use, said third polarizing filter is positioned to polarize light from said third source of light before said light reaches said object and said fourth polarizing filter, arranged to have a polarization angle substantially perpendicular to that of said third polarizing filter, is positioned to polarize the light after it has been reflected from said object. The use of such polarising filters blocks, to a great degree, light that is reflected from the surface of the said object. It should be noted that the second and fourth polarizing filters should not have different polarizing filters if they are being used with the same imaging device, as each would exclude the light that the other is intended to detect. In one arrangement, the second and fourth polarizing filters are, in fact, the same filter, with the first and third polarizing filters being arranged accordingly. In another form of the invention, two imaging devices are used so that the second and fourth polarizing filters can be different.

The light from said third source of light preferably has a wavelength in the range 400 nm to 600 nm, more preferably 500 to 600 nm and still more preferably around 540 to 570 nm. In one form of the invention, light having a wavelength of 540 nm was found to give good contrast between the flesh of a meat product and blood at or near the surface of that meat product.

A conveyor for transferring said object to a position between said third source of light and said imaging device may be provided.

The said third source of light is preferably an LED array. A collimating filter may be provided between the LED array the said object. Alternatively, a diffuser may be positioned between said LED array and said object.

In some forms of the invention, the said object is a food product. By way of example, the said food product could be a meat product, such as a chicken product, or a fish product. In another form of the invention, the object is a non-food product, one example being a person's tooth. Of course, many other applications are possible.

The present invention provides a method for detecting one or more regions within a generally light-transmissive object, the method comprising the steps of:
backlighting said object using a source of light; and
taking an image of said object as backlit by said first source of light;
wherein:
said light output by said source of light is polarized by a first polarizing filter before reaching said object and is polarized by a second polarizing filter after leaving said object;
said first and second polarizing filters are arranged to have polarization angles substantially perpendicular to one another;
said one or more regions are substantially non-light-transmissive at the frequency(s) of light output by said source of light; and
the light transmissive portions of said generally light-transmissive object perturb the polarization of said light.

The present invention further provides a method for detecting one of more regions within a generally light-transmissive object, the method comprising the steps of:
backlighting said object using a source of light;
taking an image of said object as backlit by said first source of light; and
holding said object is a position for taking said images using a holder,
wherein:
said holder is provided with gaps or holes to allow light from said light source to pass through said holder; and
said one or more regions are substantially non-light-transmissive at the frequency(s) of light output by said source of light.

The present invention also provides a method for detecting one of more regions within a generally light-transmissive object, the method comprising the steps of:
backlighting said object using a source of light; and
taking an image of said object as backlit by said first source of light,
wherein:
said source of light has a power output dependent on the dimensions of said object; and
said one or more regions are substantially non-light-transmissive at the frequency(s) of light output by said source of light.

In some forms of the invention, the light output by said source of light is polarized by a first polarizing filter before reaching said object and is polarized by a second polarizing filter after leaving said object and wherein said first and second polarizing filters are arranged to have polarization angles substantially perpendicular to one another. In some forms of the invention, the generally light-transmissive object changes the polarisation of the light that passes through it. Accordingly, light that has not passed through that object is substantially attenuated by the combination of the first and second polarising filters, but light that has passed through the said object is not generally so attenuated.

In some forms of the invention including first and second cross-polarized filters, the light transmissive portion of said generally light transmissive object perturb the polarization of said light in a generally random manner. In other forms of the invention including first and second cross-polarized filters, the light transmissive portion of said generally light transmissive object perturb the polarization of said light in a non-random manner.

The said object may be transported using a conveyor.

The said source of light may have a power output dependent on the dimensions of said object. This improves the uniformity of the light after is has passed through the generally light-transmissive object.

The said source of light may comprise a plurality of sources of light.

The method may further comprise the steps of determining the planar dimensions of said object and controlling said plurality of sources of light such that each source of light in the plurality outputs lights only when a part of said object is located between that light source of a device taking said image of said object.

The method may further comprise the steps of determining the cross-sectional dimensions of the object and controlling said plurality of sources of light such that each source of light in the plurality has a power output dependent on the cross-sectional dimension of the object at the point between that light source and a device taking said image of said object. In this way, the illumination can be provided such that, as far as possible, changes in the levels of light that has passed through the generally light-transmissive object are caused by changes in the density of that object, rather than changes in the thickness of that object.

The method may further comprise the steps of lighting said object using a second source of light and taking images of the light from said second source of light as it is reflected from said object.

The method may further comprise the step of performing blob analysis on said image of said object.

A device and method in accordance with the invention will now be described, by way of example only, with reference to the accompanying schematic drawings in which:

FIG. 1 shows a prior art apparatus for the detection of foreign bodies in meat products;

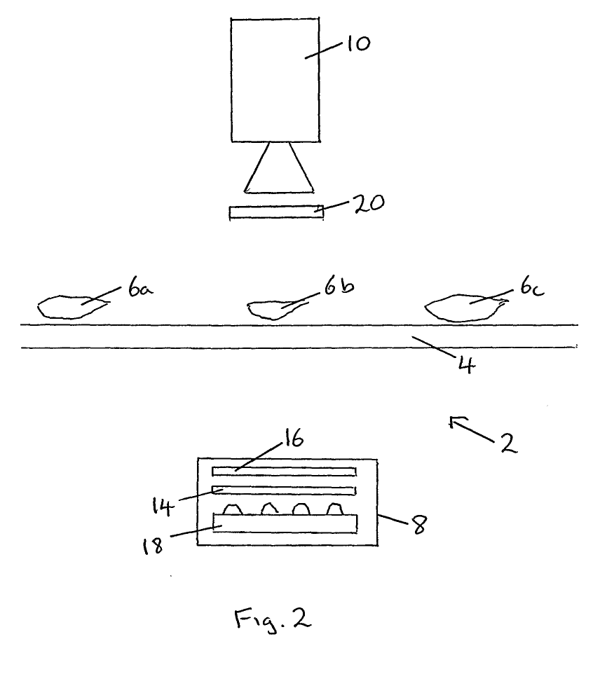

FIG. 2 shows an apparatus in accordance with a first embodiment of the invention;

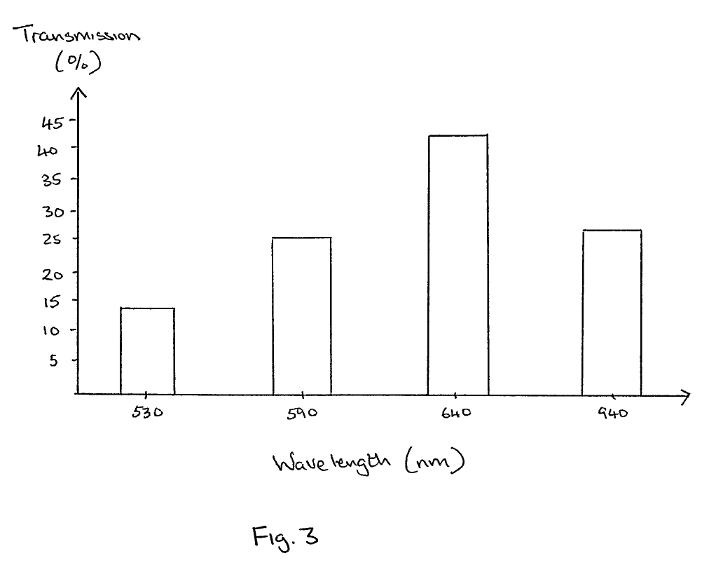

FIG. 3 is a graph showing measured transmission of light through a chicken breast fillet at different wavelengths of light;

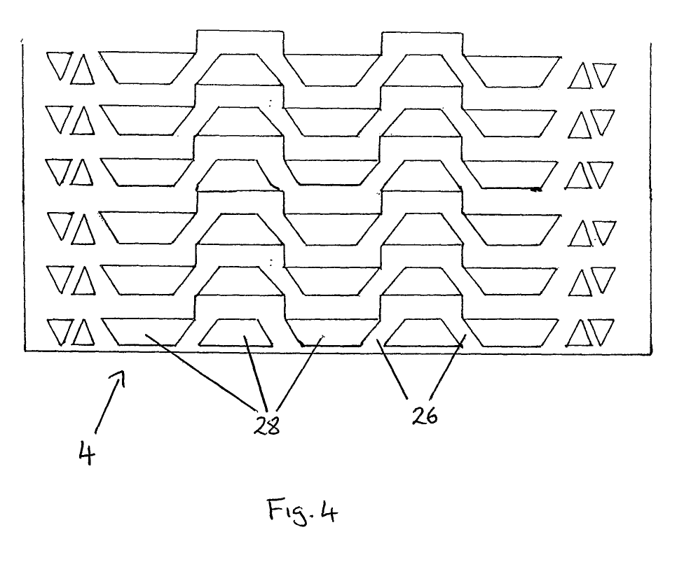

FIG. 4 is a plan view of part of a conveyor used in the invention;

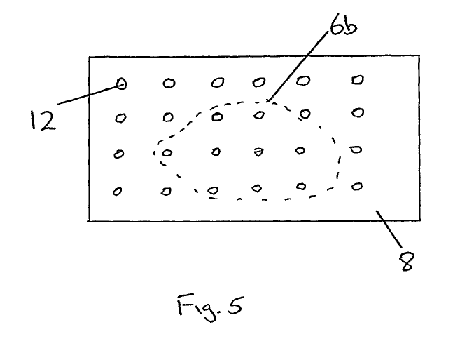

FIG. 5 is a plan view of an LED array used in the present invention;

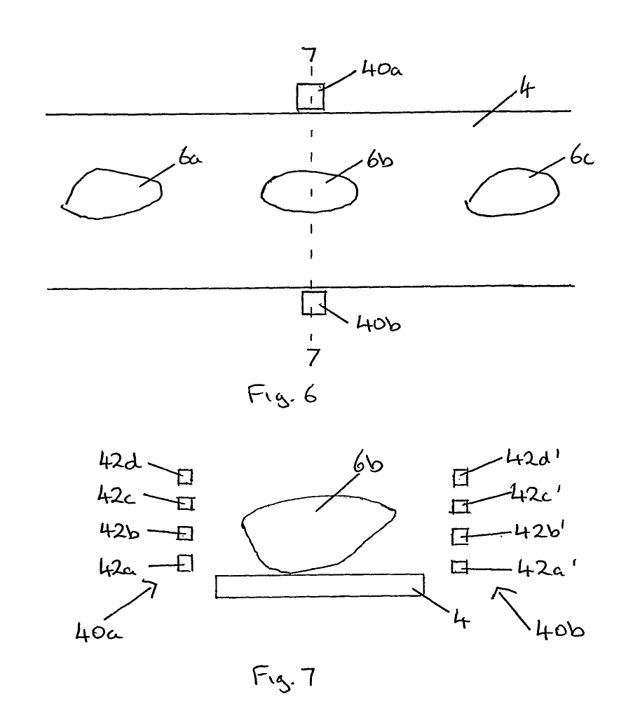

FIG. 6 is a plan view of a conveyor in accordance with an aspect of the present invention;

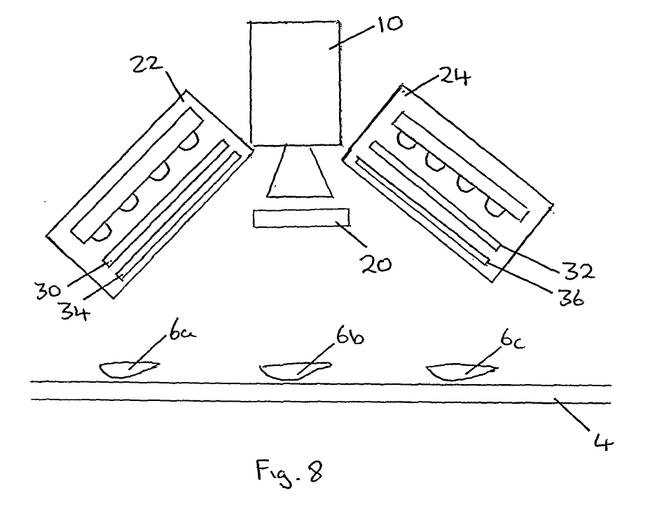

FIG. 7 is a schematic cross-section taken along the line 7-7 in FIG. 6;

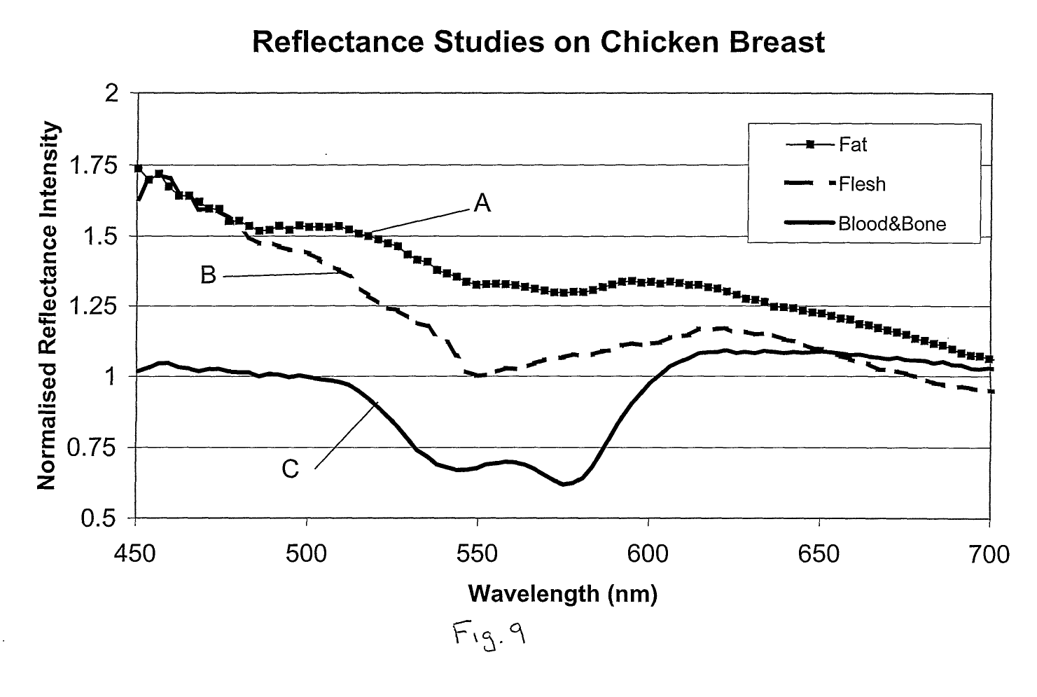

FIG. 8 is a schematic cross-section demonstrating the use of an imaging device in the present invention;

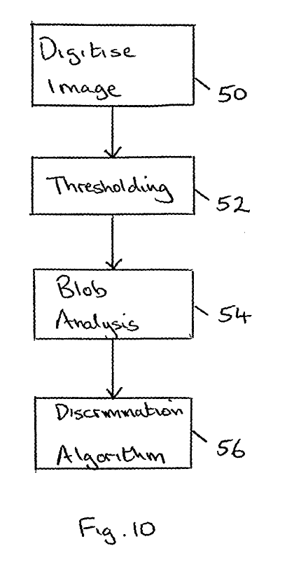

FIG. 9 shows is a graph showing measured reflectance of light from different parts of a chicken breast fillet at different wavelengths of light; and

FIG. 10 is a flow chart demonstrating a method of analysing the images generated in the present invention.

FIG. 2 is a schematic representation of an apparatus, indicated generally by the reference numeral 2, in accordance with a first embodiment of the invention. The apparatus 2 includes a conveyor 4 on which chicken breast fillets 6a, 6b and 6c are moved. An LED array 8 is located below the conveyor 4. An imaging device 10 is located above the conveyor.

In the use of the apparatus 2 to detect foreign bodies in meat products, such as fillets 6a, 6b and 6c, the fillets are transferred along the conveyor 4 (from left to right in the example of FIG. 2). In the example of FIG. 2, the fillet 6b is positioned between the LED array 8 and the imaging device 10. The LED array 8 is used to backlight the fillet 6b and, at the same time, an image of the fillet is taken by the imaging device 10.

By using light that has a relatively high transmission through the chicken meat, the presence of foreign bodies, such as bone, that block the light can be readily detected from the image taken by the imaging device 10. (The presence of a foreign body is indicated by the presence of a dark portion in the image generated by the imaging device 10.) FIG. 3 is a graph showing measured transmission of light through chicken meat at different wavelengths. As shown in the graph, the transmission is highest when red light is used. For this reason, red (640 nm) or near-infra-red light is used in one form of this invention.

At least two problems have been identified with the use of an array 8 to provide backlighting as shown in FIG. 2. First, the image generated by the imaging device 10 can include images of the individual LEDs in the array 8. Second, light passing through the fillet is strongly attenuated, whereas light not passing through the fillet is not so attenuated. This can lead to glare being visible around the image of the chicken breast fillet. Such glare can make it difficult to discern dark patches in the image that are caused by light that has been blocked by portion of the object under test.

In the apparatus 2 of FIG. 2, a diffuser 14 and a polarizing filter 16 are provided between the LEDs of the array 8 and the conveyor 4. A second polarizing filter 20 is provided between the conveyor 4 and the imaging device 10. The diffuser 14 is provided to diffuse the light from the LEDs in the array 8 in order to remove the images of the individual LEDs in the image produced by the imaging device 10. The polarizing filter 16 passes light having a particular polarisation. In this way, diffuse, linearly polarized light is directed towards the conveyor 4.

Chicken breast meat is a diffuse scattering medium that changes the polarization of light that passes through it in a generally random manner. Accordingly, light that has not passed through the chicken breast fillet will retain the linear polarization, but light that has passed through the chicken will not. Thus, by providing a second polarizing filter 20 as part of the imaging device 10 that has an angle of polarization set perpendicular to that of the polarizing filter 16, linearly polarized light that does not pass through the chicken breast fillet will be substantially attenuated by the filter 20, but light passing through the chicken will not generally be so attenuated. In this way, the majority of the image formed by the imaging device 10 is derived from light that has passed through the fillet 6b. Thus, the problem of glare caused by light that does not pass through the chicken breast fillet being brighter than light that does pass through the chicken breast fillet is significantly reduced.

The imaging technique of the present invention relies on a substantial amount of light passing from the LED array 8 through the chicken breast fillet and on to the imaging device 10. High power LEDs are commercially available to meet the requirements of the system, but heat management is a significant issue. As shown in FIG. 2, the LED array 8 is provided with a heat sink 18. Other heat management techniques could be used in addition to, or instead of, the heat sink 18. Many suitable heat management systems would be known to the person skilled in the art.

FIG. 4 is a plan view of part of the conveyor 4. As shown in FIG. 4, the conveyor 4 comprises a chain arrangement of an opaque material 26. A substantial number of gaps, such as holes 28, allow light to pass through the conveyor 4. The opaque material 26 may, for example, be polypropylene; many other suitable materials would be apparent to the person skilled in the art.

In the use of the conveyor 4, light is blocked by the opaque material 26 of the conveyor but is allowed to pass through the holes 28 in the chain arrangement. In this way, a significant amount of light can pass through the conveyor. The use of an opaque material for the conveyor is preferred to the use of a flexible transparent material, since transparent materials generally change the polarization of light in an uncontrollable manner. Thus, using a transparent material would render the glare-reduction technique described above ineffective. It should be noted that the scattering effect of the chicken breast means that the image of the chain arrangement of the conveyor is not generally visible in the image generated by the imaging device 10. In tests, it was found that the chain arrangement was no longer visible provided that the meat has a thickness of at least 5 mm.

The chain arrangement of the conveyor shown in FIG. 4 is not essential. For example, the conveyor could take the form of a number of rollers made from an opaque material, with the rollers being spaced to provide gaps through which light can pass.

FIG. 5 shows a schematic plan view of the LED array 8. The LED array 8 comprises a number of high power LEDs, arranged in a rectangular array. Superimposed onto the array shown in FIG. 5 is the outline of the chicken breast fillet 6b; that outline is illustrated using a dotted line. The outline shows the position of the chicken fillet 6b above the LED array 8. As can be seen, not all of the LEDs are below the chicken breast. For example, LED 12 in the top left hand corner of the array 8 is not below the chicken fillet 6b. It is advantageous if light passing from the array 8 to the imaging device 10 that does not pass through the chicken breast 6b is kept to a minimum since light passing through the chicken fillet is strongly attenuated but light not passing through the chicken is not so attenuated. This can lead to glare being visible around the image of the chicken fillet. Further, since the LEDs in the array 8 generate heat as well as light, any unwanted light also generates unwanted heat. Heat generation should be kept to a minimum as heat generation not only risks heating the chicken breast fillets to an unacceptable degree, but also places unnecessary strain on the heat management system associated with the LED array 8.

Of course, it is not essential that the LEDs be arranged in a rectangular array. Many other suitable arrangements would be readily apparent to the person skilled in the art.

Accordingly, in a preferred form of the invention, the LED array 8 is controlled so that only the LEDs below the chicken fillet are activated.

The size of the chicken bone which may be detected in such a system on a moving conveyor belt will depend on the quality of the image taken. To facilitate a very sharp image either the light source, in this case LEDs, are illuminated only over a very short period of time similar to a camera flash or the capture time of the camera is made very short so that the image is not blurred. The system demonstrated here has a conveyor speed of 0.3 metres/sec and thus the acquisition time for the camera or the flash time needs to be less than 1 milli-second for good resolution to detect bone piece feature sizes of around 2 mm.

FIG. 6 is a schematic plan view of the conveyor 4 in which chicken breast fillets 6a, 6b and 6c are visible. Also shown in FIG. 6 are an emitter 40a and a receiver 40b that form an emitter-receiver pair. The emitter 40a and receiver 40b are located opposite one another on different sides of the conveyor 4. The emitter 40a and receiver 40b are arranged so that a signal output by the emitter 40a is received by the receiver 40b in the absence of any object blocking the path of that signal. Thus, in the exemplary situation of FIG. 6 in which a chicken breast fillet 6b is located between the emitter 40a and the receiver 40b, no signal is received at the receiver. In this way, the presence of a fillet on the conveyor 4 can be detected.

FIG. 7 is a cross-section, taken along the line 7-7 of FIG. 6, of one particular arrangement of the emitter-receiver pair of FIG. 6. In the example of FIG. 7, the emitter 40a comprises four directional light sources 42a, 42b, 42c and 42d and the receiver 40b comprises four receivers 42a′, 42b′, 42c′ and 42d′. The emitters and receivers are arranged in pairs so that a signal emitted by light source 42a is received at receiver 42a′. Signals emitted by light sources 42b, 42c and 42d are received at receivers 42b′, 42c′ and 42d′ respectively. The light sources 42a, 42b, 42c and 42d may be LEDs: the receivers 42a′, 42b′, 42c′ and 42d′ may be photodetectors. Other arrangements would be apparent to the skilled person.

In the example of FIG. 7, a chicken breast fillet 6b is located between the emitter and receiver pair 40a and 40b. However, whilst the fillet is sufficiently large to block the signal between emitters 42a, 42b and 42c and the corresponding receivers 42a′, 42b′ and 42c′, it is not sufficiently large to block the signal between emitter 42d and receiver 42d′. In this way, it is possible to determine the height of the fillet 6b.

Thus, as the chicken breast fillet is moved by the conveyor past the emitter-receiver pair 40a and 40b, a series of measurements of the cross-sectional dimensions of the fillet can be taken.

As described with reference to FIG. 5, the LEDs of the array 8 may be inactive if they fall within an area that is not below a chicken breast fillet. Further, the power output of the LEDs of the array 8 may be made dependent on the height of the chicken breast. Thus, the power output may be larger for larger fillets. The power may also be varied for a particular fillet so that the power output of a particular LED in the array 8 is dependent on the size of the chicken breast fillet that is above that LED.

In one form of the invention, chicken breast meat is calibrated so that there is a known relationship between the LED input current for each LED and the height of the chicken fillet in association with the capture time and aperture of the camera. The aim is to provide a flat illumination field so that changes in light level within the chicken breast are due to density changes caused by the presence of foreign material or bone and not the thickness of the chicken breast.

The LEDs may be individually controllable so that individual LEDs can be activated or inactivated, depending on the size of the chicken breast fillet. Alternatively, the LEDs may be arranged in small groups, with each group being controllable but the LEDs in the groups not being individually controllable. Although arranging the LEDs in the LED array into groups leads to a reduction in the control over the LEDs in the array, it also reduces the processing and wiring requirements of the system.

FIG. 8 shows an arrangement of the imaging device 10 used in an embodiment of the present invention. As described above, a second polarizing filter 20 is provided in front of the imaging device 10 so that linearly polarized light that does not pass through a scattering medium such as chicken is substantially attenuated. Further, as shown in FIG. 8, LED arrays 22 and 24 that can be used to direct light towards the conveyor 4 are also provided, together with diffusers 30 and 32.

The diffusers 30 and 32 as shown in FIG. 8 may be omitted and replaced with collimating lenses to ensure maximum transfer of light to the chicken surface. The light level at the chicken surface may be altered by changing the LED current in each LED to provide a uniform illumination profile.

As described with reference to FIG. 7, emitter and receiver pair 40a and 40b can be used to determine the cross-sectional dimensions of a meat product. The imaging device 10, as arranged in FIG. 8, can be used to determine the planar dimensions of the meat product so that the appropriate LEDs in the array 8 shown in FIG. 5 can be activated.

When the presence of a meat product is detected (for example by emitter-receiver pairs 40a and 40b), the LED arrays 22 and 24 flash briefly and the imaging device 10 takes an image of the chicken breast fillet as illuminated by the LED arrays 22 and 24. This image can be used to determine the planar dimensions of the meat product.

As described above, the LEDs in the array 8 can be controlled (either individually or in groups) so that only those LEDs below the chicken fillet are turned on. In addition, the use of the emitter-receiver pair described in FIG. 7 enables a finer degree of control of the LEDs. The presence of four emitter (42a, 42b, 42c and 42d) and four receivers (42a′, 42b′, 42c′ and 42d′) enables the cross-sectional size of the chicken breast fillet to be determined to five levels (from none of the emitter-receiver pairs being blocked by the chicken breast fillet to all four of the emitter-receiver pairs being blocked by the chicken breast fillet).

In one embodiment of the invention, the individual LEDs in the array 8 can be set to any one of five power levels, from being turned off when no chicken breast fillet is detected to being fully on when all of the emitter-receiver pairs are blocked by the chicken breast fillet. In this way, the power emitter by an LED in the array is determined by the measured thickness of the chicken breast fillet above that LED. This effect can also be achieved by providing four LEDs in a group, with no LEDs being illuminated when no chicken breast is detected, one LED being illuminated when only emitter-receiver pair 42a and 42a′ are blocked, two LEDs being illuminated when only emitter-receiver pairs 42a and 42a′ and 42b and 42b′ are blocked, three LEDs being illuminated when only emitter-receiver pairs 42a and 42a′, 42b and 42b′ and 42c and 42c′ are blocked, and all four LEDs being illuminated when emitter-receiver pairs 42a and 42a′, 42b and 42b′, 42c and 42c′ and 42d and 42d′ are blocked.

Of course, many more arrangements for the variable power setting of the light source would be apparent to the skilled person. For example, more than four emitter-receiver pairs could be provided.

A number of features of an apparatus capable of determining the presence of foreign bodies in meat products have now been described. These features can be used together as described below. It should be noted that in a particular embodiment of the invention, one or more of the following steps may be omitted.

1. The presence of a chicken breast fillet is detected by emitter and receiver pair 40a and 40b;
2. LED arrays 22 and 24 flash briefly when a chicken breast fillet approaches the area at which an image will be taken;
3. Imaging device 10 takes an image of the chicken breast fillet as illuminated by the LED arrays 22 and 24 to determine the planar dimensions of the chicken breast fillet;
4. The emitters and receivers of the emitter and receiver pair 40a and 40b are used to determine the height profile of the chicken breast;
5. The output of the LED array 8 is optimised based on the position and dimensions of the chicken breast fillet;
6. The LED array 8 so optimised is flashed to provide backlighting for the imaging device 10; and
7. An image of the backlit chicken breast fillet is taken using the imaging device 10.

The top-down illumination scheme shown in FIG. 8 can also be used to provide a contrast between discoloured meat and normally coloured meat. Accordingly, the apparatus of FIG. 8 can be used in the detection of discoloured meat, for example meat that has been discoloured as a result of blood spotting or bruising or other types of damage or contamination.

The discolouration detection method relies on the fact that different substances reflect light differently. For example, chicken flesh, blood, bone and fat all reflect light differently.

FIG. 9 is a graph showing the measured reflectance of light over a range of frequencies from fat (line a), flesh (line b) and blood and bone (line c).

As can be seen in FIG. 9, the reflectance for blood and bone dips significantly for light having wavelengths of 540 nm and 580 nm (green and yellow light respectively). Also shown in FIG. 9 is that the reflectance for all substances converges at longer wavelengths of light, such as the red and near infra-red light proposed for use with the backlighting arrangement described above. It should be noted that the backlighting method described above relies on the change in density, and therefore the change in absorption of light, between flesh and bone, to determine the presence of bone, rather than the change in reflectance shown in FIG. 9.

As discussed above with reference to FIG. 8, LED arrays 22 and 24 flash green light at the chicken breast fillets as they pass on the conveyor 4. The light reflected from the fillets is captured by the imaging device 10.

It has been found that green light (540 nm) gives good contrast between blood and normal flesh.

In the use of the system of FIG. 8 to detect discolouration of meat products, green light is flashed at the meat product by LED arrays 22 and 24. The reflected light is captured by the imaging device 10. LED array 22 includes a collimating lens arrangement 30. A similar lens arrangement 32 is provided with the LED array 24. LED array 22 also includes a polarizing filter 34 to polarize the light directed towards the meat product. LED array 24 includes a similar polarizing filter 36.

The imaging device 10 is provided with a polarizing filter 20, as described above. The polarizing angle of the polarizing filter 20 is set perpendicular to that of the polarizing filters 34 and 36. This ensures that only light that has been passed through at least part of the scattering meat product passes through the filter 20. This is useful since meat products such as chicken breast fillets are generally highly reflective. Information relating to discoloration of the meat product is obtained from light that has passed a short distance into the meat product and then been reflected. If the substantial amount of light reflected from the surface of the meat product is allowed to reach the imaging device 10, the information from the light that has passed a short distance into the meat product (i.e. the light carrying the information of interest) will be swamped by the light reflected from the surface.

A number of features of an apparatus capable of detecting discolouration at the surface of chicken breast fillets have now been described. These features can be used together as described below.

1. The presence of a chicken breast fillet is detected by emitter and receiver pair 40a and 40b;
2. LED arrays 22 and 24 flash briefly when a chicken breast fillet reaches the area at which an image will be taken; and
3. Imaging device 10 takes an image of the chicken breast fillet as illuminated by the LED arrays 22 and 24 for use in determining whether there is any discolouration of the meat surface.

The methods described above for detecting the presence of foreign bodies in a chicken breast fillet and for detecting discolouration on such fillets can be combined. Such a combined imaging method may comprise the steps listed below. It should be noted that in a particular embodiment of the invention, one or more of the following steps may be omitted.

1. The presence of a chicken breast fillet is detected by emitter and receiver pair 40a and 40b;
2. LED arrays 22 and 24 flash briefly when a chicken breast fillet approaches the area at which an image will be taken;
3. Imaging device 10 takes an image of the chicken breast fillet as illuminated by the LED arrays 22 and 24 to determine the planar dimensions of the chicken breast fillet and to determine whether or not there is any discolouration of the meat surface;
4. The emitters and receivers of the emitter and receiver pair 40a and 40b are used to determine the height profile of the chicken breast;
5. The output of the LED array 8 is optimised based on the position and dimensions of the chicken breast fillet;
6. The LED array 8 so optimised is flashed to provide backlighting for the imaging device 10; and
7. An image of the backlit chicken breast fillet is taken using the imaging device 10.

As discussed above, in some forms of the invention, the imaging device 10 receives light from LED array 8 that has passed through a chicken breast fillet. The chicken breast fillet is a generally light-transmissive product. Accordingly, a quantity of light sufficient to form an image is received at the imaging device 10. However, in the presence of an object in the fillet that is not light-transmissive, such as a bone fragment, a dark portion will be present in the image produced by the imaging device 10. In order for the detection of bone fragments and the like to be further automated, the detection of such dark regions must also be at least partially automated.

In some other forms of the invention, the imaging device receives light from LED arrays 22 and 24 that has been reflected from a chicken breast fillet. It has been found that normal chicken breast meat reflects light well, but that blood and other causes of discoloration do not reflect light as well. Accordingly, the presence of such discoloration also causes the presence of dark regions in the image generated by the imaging device 10. Thus, in common with the detection of bone fragments and the like, in order for the detection of discoloration to be further automated, the detection of such dark regions must also be at least partially automated.

The amount of light received at the imaging device 10 can be measured and a spatial plot of light intensity generated. By viewing this plot, an operator can determine which areas are bright, and which areas are dark. However, as discussed above, it would be advantageous to automate this step, at least to some degree.

FIG. 10 shows a flow chart showing one method of automating the detection of bone fragments and blood discoloration. As shown in FIG. 10, the first step (step 50) is to digitise the image 50 generated by the image generator 10. The digital image is then applied to a binary thresholding step 52. Blob analysis is performed on the resulting data at step 54 before a discrimination algorithm is carried out at step 56.

The thresholding step 52 merely determines which parts of the digitised image are deemed to be dark, and which are deemed to be light. This is achieved by setting a light threshold, below which the image is deemed to be dark and above which the image is deemed to be light. This step is likely to require simple on-site calibration. Some filtering may also be required at this stage to remove noise in the data.

Once the dark areas of the image have been determined, blob analysis can be performed at step 54. Blob analysis is a well established image processing technique. A blob in this context is simply a set of connected image pixels that are deemed to be dark. By performing blob analysis in the present invention, different shapes of dark regions can be determined. Then, in the discrimination step 56, meanings can be attributed to the blobs determined in the step 54. For example, experience may show that particular defects (such as bone fragments) typically result in a certain size and/or shape of blob. Thus, the detection of a particular size and shape of blob may lead to the conclusion that that defect has been found.

Blob analysis is a well established technique that is well known to persons skilled in the art. Accordingly, further discussion of the technique is not required here.

The invention has been described above in relation to chicken breast fillet. The present invention is not limited to use with chicken breast fillets. The present invention could be used with any meat product that has a sufficiently high level of light transmission. Pork and fish are two examples for which the present invention is particularly well suited.

Furthermore, the invention is not limited to meat products. Other food and non-food items could be checked in a similar way. For example, defects in many food items could be detected using one or more of the techniques described herein. Other examples include the detection of discolouration or bruising in fruit, the detection of bones in fish and the detection of defect in processed foods such as potato crisps etc. There are also a number of medical applications, such as imaging testicles, or the hand or wrist, as well as a number of veterinary applications. One particular example could be the imaging of blood flow in the hand as a means of determining blood circulation issues. There are also a number of potential dental applications, such as taking images of teeth, or taking images of the root of a tooth in the gum of a patient.

The invention has been described with reference to objects that perturb the polarization of light passing therethrough in a generally random manner, but could also be used with object that perturb the polarization of light passing therethrough in a non-random manner.

In each of the embodiments described above, light emitting diodes (LEDs) are used as the light sources. The use of LEDs in not essential: lamp-based or scanned laser light sources are alternatives. Nevertheless, there are a number of advantages associates with using LEDs. For example, LEDs have a narrow wavelength emission which means that the desired wavelength can be reliably obtained. Further, LEDs can be quickly turned on and off, especially when compared with traditional lamp systems and cover a large spatial area compared with laser systems. The fast switching speed enables sharp images to be obtained, thereby improving the accuracy of the system. The use of LEDs is efficient; this is advantageous since it reduces the heat output of the light sources.

A number of forms of the present invention are described herein. Several of those forms have a number of variants. The skilled person will be aware that any of the variants may be applied to any of the forms of the invention. Accordingly, the present invention is not limited to the specific forms of the invention described herein.

1. An apparatus suitable for use in the detection of one or more regions within a generally light-transmissive object, the apparatus comprising a source of light, an imaging device and first and second polarizing filters, wherein:
said one or more regions are substantially non-light-transmissive at the frequency(s) of light output by said source of light;
light transmissive portions of said generally light-transmissive object perturb the polarization of said light;
in use, said source of light is used to backlight said object and said imaging device is used to take an image of said object when said object is backlit by said source of light; and
said first polarizing filter is positioned to polarize said light before transmission of said light through said object and said second polarizing filter, arranged to have a polarization angle substantially perpendicular to that of said first polarizing filter, is positioned to polarize the light after transmission through said object.

2. An apparatus suitable for use in the detection of one or more regions within a generally light-transmissive object, the apparatus comprising a source of light, an imaging device and a holder for holding said object in a position between said source of light and said imaging device, wherein:
said one or more regions are substantially non-light-transmissive at the frequency(s) of light output by said source of light;
in use, said source of light is used to backlight said object and said imaging device is used to take an image of said object when said object is backlit by said source of light; and
said holder is provided with gaps to allow light from said light source to pass through said holder.

3. (canceled)

4. An apparatus as claimed in claim 2, further comprising a first and a second polarizing filter, wherein light transmissive portions of said generally light-transmissive object perturb the polarization of said light, and wherein, in use, said first polarizing filter is positioned to polarize said light before transmission of said light through said object and said second polarizing filter, arranged to have a polarization angle substantially perpendicular to that of said first polarizing filter, is positioned to polarize the light after transmission through said object.

5. A apparatus as claimed in claim 4, wherein said light transmissive portions of said generally light transmissive object perturb the polarization of said light in a generally random manner.

6. (canceled)

7. (canceled)

8. An apparatus as claimed in claim 2, wherein said holder is made of a substantially opaque material.

9. An apparatus as claimed in claim 3, wherein said holder is a conveyor arranged to transfer said object to said position between said source of light and said imaging device.

10. An apparatus as claimed in claim 2, wherein said source of light has a power output dependent on the dimensions of said object.

11. An apparatus as claimed in claim 2, wherein said source of light comprises a plurality of sources of light.

12. An apparatus as claimed in claim 11, further comprising means for determining the planar dimensions of the object, wherein each of said plurality of light sources outputs light only when a part of said object is located between that light source and said imaging device.

13. An apparatus as claimed in claim 12, wherein said means for determining the planar dimensions of the object comprises a second source of light, wherein said second source of light is used to light said object and said imaging device is used to take an image of the light from said second light source that is reflected from said object, thereby obtaining an image of said second object.

14. An apparatus as claimed in claim 11, further comprising means for determining the cross-sectional dimensions of the object, wherein each of said plurality of light sources is arranged so that the power output of that light source is dependent on the cross-sectional dimensions of the object.

15. An apparatus as claimed in claim 14, wherein the power output of each light source in the plurality is dependent on the cross-sectional dimension of the object at the point between that light object and the imaging device.

16. An apparatus as claimed in claim 14, wherein said means for determining the cross-sectional dimensions of the object comprises an emitter-receiver pair located either side of said object.

17. An apparatus as claimed in claim 2, wherein said light has a wavelength in the range 600 nm to 1000 nm.

18. An apparatus as claimed in claim 2, wherein said source of light is an LED array.

19. An apparatus as claimed in claim 2, further comprising a diffuser positioned between said LED array and said object.

20. An apparatus as claimed in claim 2, wherein said one or more regions include a foreign body.

21. An apparatus as claimed in claim 2, wherein said one or more regions include bone.

22. An apparatus as claimed in claim 2, further comprising a third source of light, wherein said apparatus is suitable for use in the detection of one or more second regions, wherein said one or more second regions have a different reflectivity to the remainder of the object at the frequency(s) of light output by said third source of light, wherein, in use, said third source of light is used to light said object and said imaging device is used to take an image of the light as it is reflected from said object.

23. An apparatus as claimed in claim 22, further comprising a third and a fourth polarizing filter, wherein, in use, said third polarizing filter is positioned to polarize said light from said third source of light before said light reaches said object and said fourth polarizing filter, arranged to have a polarization angle substantially perpendicular to that of said third polarizing filter, is positioned to polarize the light after it has been reflected from said object.

24. An apparatus as claimed in claim 2, wherein said object is a food product.

25. An apparatus as claimed in claim 24, wherein said object is a meat product.

26. A method for detecting one or more regions within a generally light-transmissive object, the method comprising the steps of:
backlighting said object using a source of light; and
taking an image of said object as backlit by said first source of light;
wherein:
said light output by said source of light is polarized by a first polarizing filter before reaching said object and is polarized by a second polarizing filter after leaving said object;
said first and second polarizing filters are arranged to have polarization angles substantially perpendicular to one another;
said one or more regions are substantially non-light-transmissive at the frequency(s) of light output by said source of light; and
the light transmissive portions of said generally light-transmissive object perturb the polarization of said light.

27. A method for detecting one of more regions within a generally light-transmissive object, the method comprising the steps of:
backlighting said object using a source of light;
taking an image of said object as backlit by said first source of light; and
holding said object in a position for taking said images using a holder,
wherein:
said holder is provided with gaps to allow light from said light source to pass through said holder; and
said one or more regions are substantially non-light-transmissive at the frequency(s) of light output by said source of light.

28. (canceled)

29. A method as claimed in claim 27, wherein light transmissive portions of said generally light-transmissive object perturb the polarization of said light, and wherein said light output by said source of light is polarized by a first polarizing filter before reaching said object and is polarized by a second polarizing filter after leaving said object and wherein said first and second polarizing filters are arranged to have polarization angles substantially perpendicular to one another.

30. (canceled)

31. (canceled)

32. A method as claimed in claim 27, wherein said source of light has a power output dependent on the dimensions of said object.

33. (canceled)

34. A method as claimed in claim 27, wherein said source of light comprises a plurality of sources of light.

35. A method as claimed in claim 34, further comprising the steps of determining the planar dimensions of said object and controlling said plurality of sources of light such that each source of light in the plurality outputs lights only when a part of said object is located between that light source of a device taking said image of said object.

36. A method as claimed in claim 34, further comprising the steps of determining the cross-sectional dimensions of the object and controlling said plurality of sources of light such that each source of light in the plurality has a power output dependent on the cross-sectional dimension of the object at the point between that light source and a device taking said image of said object.

37. A method as claimed in claim 27, further comprising the steps of lighting said object using a second source of light and taking images of the light from said second source of light as it is reflected from said object.

38. (canceled)

39. A method as claimed in claim 27, further comprising the step of performing blob analysis on said image of said object.

40. An apparatus as claimed in claim 1, wherein said light transmissive portions of said generally light transmissive object perturb the polarization of said light in a generally random manner.

41. An apparatus comprising a source of light and an imaging device, wherein the apparatus is suitable for use in the detection of one or more regions within a generally light-transmissive object, wherein said one or more regions are substantially non-light-transmissive at the frequency(s) of light output by said source of light, wherein, in use, said source of light is used to backlight said object and said imaging device is used to take an image of said object when said object is backlit by said source of light, wherein said source of light has a power output dependent on the dimensions of said object.

42. An apparatus as claimed in claim 41, wherein said source of light comprises a plurality of sources of light.

43. An apparatus as claimed in claim 42, further comprising means for determining the planar dimensions of the object, wherein each of said plurality of light sources outputs light only when a part of said object is located between that light source and said imaging device.

44. An apparatus as claimed in claim 43, wherein said means for determining the planar dimensions of the object comprises a second source of light, wherein said second source of light is used to light said object and said imaging device is used to take an image of the light from said second light source that is reflected from said object, thereby obtaining an image of said second object.

45. An apparatus as claimed in claim 42, further comprising means for determining the cross-sectional dimensions of the object, wherein each of said plurality of light sources is arranged so that the power output of that light source is dependent on the cross-sectional dimensions of the object.

46. An apparatus as claimed in claim 45, wherein the power output of each light source in the plurality is dependent on the cross-sectional dimension of the object at the point between that light object and the imaging device.

47. An apparatus as claimed in claim 45, wherein said means for determining the cross-sectional dimensions of the object comprises an emitter-receiver pair located either side of said object.

48. A method for detecting one of more regions within a generally light-transmissive object, the method comprising the steps of:
backlighting said object using a source of light; and
taking an image of said object as backlit by said first source of light,
wherein:
said source of light has a power output dependent on the dimensions of said object; and
said one or more regions are substantially non-light-transmissive at the frequency(s) of light output by said source of light.

49. A method as claimed in claim 48, wherein said source of light comprises a plurality of sources of light.

50. A method as claimed in claim 49, further comprising the steps of determining the planar dimensions of said object and controlling said plurality of sources of light such that each source of light in the plurality outputs lights only when a part of said object is located between that light source of a device taking said image of said object.

51. A method as claimed in claim 49, further comprising the steps of determining the cross-sectional dimensions of the object and controlling said plurality of sources of light such that each source of light in the plurality has a power output dependent on the cross-sectional dimension of the object at the point between that light source and a device taking said image of said object.

52. A method as claimed in claim 48, further comprising the step of performing blob analysis on said image of said object.
